(19) United States
(12) Patent Application Publication
(10) Pub. No.: US 2021/0365043 A1
(43) Pub. Date: Nov. 25, 2021

(54) SYSTEM AND METHOD FOR GUIDING VEHICLES AND COMPUTER PROGRAM PRODUCT

(71) Applicants: MICRO-STAR INT'L CO., LTD., New Taipei City (TW); MSI COMPUTER (SHENZHEN) CO., LTD., Shenzhen City (CN)

(72) Inventors: Hoa-Yu CHAN, Taipei City (TW); Yu-Cheng CHENG, Pingtung County (TW); Felix Alan LIN, Taipei City (TW); Shih-Che HUNG, Taoyuan City (TW)

(73) Assignees: MICRO-STAR INT'L CO., LTD., New Taipei City (TW); MSI COMPUTER (SHENZHEN) CO., LTD., Shenzhen City (CN)

(21) Appl. No.: 17/005,507

(22) Filed: Aug. 28, 2020

(30) Foreign Application Priority Data
May 21, 2020 (TW) 109116832

(51) Int. Cl. G05D 1/02; G08G 9/02; G01C 21/34; G01C 21/00

(52) U.S. Cl. CPC G05D 1/0287; G08G 9/02; G05D 1/0212; G01C 21/3833; G01C 21/3407

(57) ABSTRACT

A system for guiding vehicles is provided. The system includes a first vehicle, a second vehicle, and a host terminal. The first vehicle is configured to move in a first space. The second vehicle is configured to move in a second space. The host terminal includes a computer program product and a processor. In response to the processor executing the computer program product, the host terminal performs an interactive operation with at least one of the first vehicle and the second vehicle. The interactive operation includes receiving first position information of the first vehicle; receiving second position information of the second vehicle; receiving destination information; according to the first position information, the second position information, the destination information, and environmental characteristics of a map, planning a travelling path on the map; and controlling a movement route of the first or second vehicle according to the travelling path.

### CROSS REFERENCE TO RELATED APPLICATIONS

This application claims priority of Taiwan Patent Application No. 109116832, filed on May 21, 2020, the entirety of which is incorporated by reference herein.

### BACKGROUND OF THE INVENTION

### Field of the Invention

This invention is related to a system for guiding vehicles, and in particular it is related to a system for guiding vehicles that simulates the travelling path of a vehicle and assigns tasks to the vehicle based on the simulation result.

### Description of the Related Art

In certain environments where there are a large number of tasks (such as production lines for maintenance, transportation channels, and building walkways), multiple unmanned vehicles or unmanned fleets are usually used to complete these tasks (such as transportation and cleaning), in order to balance safety and efficiency. However, in a field with a large area but a narrow working space, or when there are multiple tasks scheduled at the same time, the moving routes of vehicles may overlap and stagger, causing collisions between the vehicles.

### BRIEF SUMMARY OF THE INVENTION

An exemplary embodiment of the present invention provides a system for guiding vehicles. The system comprises a first vehicle, a second vehicle, and a host terminal. The first vehicle is configured to move in a first space. The second vehicle is configured to move in a second space. The host terminal comprises a computer program product and a processor. In response to the processor executing the computer program product, the host terminal performs an interactive operation with at least one of the first vehicle and the second vehicle. The interactive operation comprises receiving first position information of the first vehicle; receiving second position information of the second vehicle; receiving destination information; according to the first position information, the second position information, the destination information, and environmental characteristics of a map, planning a travelling path on the map; and controlling a movement route of the first or second vehicle according to the travelling path.

An exemplary embodiment of the present invention provides a method for guiding vehicles, which is applied to a host terminal. The host terminal comprises a computer program product and a processor and performs an interactive operation with a first vehicle or a second vehicle in response to the processor executing the computer program product. The method for guiding vehicles comprises the steps of receiving first position information of the first vehicle; receiving second position information of the second vehicle; receiving destination information; according to the first position information, the second position information, the destination information, and a map, planning a travelling path on the map; and controlling a movement route of the first or second vehicle according to the travelling path.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing a system for guiding vehicles according to an exemplary embodiment of the present invention;

FIG. 2A is a schematic diagram showing a map according to one exemplary embodiment of the present invention;

FIG. 2B is a schematic diagram showing a map according to another exemplary embodiment of the present invention;

FIG. 3A is a schematic diagram showing a map according to one exemplary embodiment of the present invention;

FIG. 3B is a schematic diagram showing a map according to another exemplary embodiment of the present invention;

FIG. 4 is a schematic diagram showing travelling paths according to one exemplary embodiment of the present invention;

FIG. 5 is a schematic diagram showing travelling paths according to another exemplary embodiment of the present invention; and

FIG. 6 is flow chart of a method for guiding vehicles according to an exemplary embodiment of the present invention.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

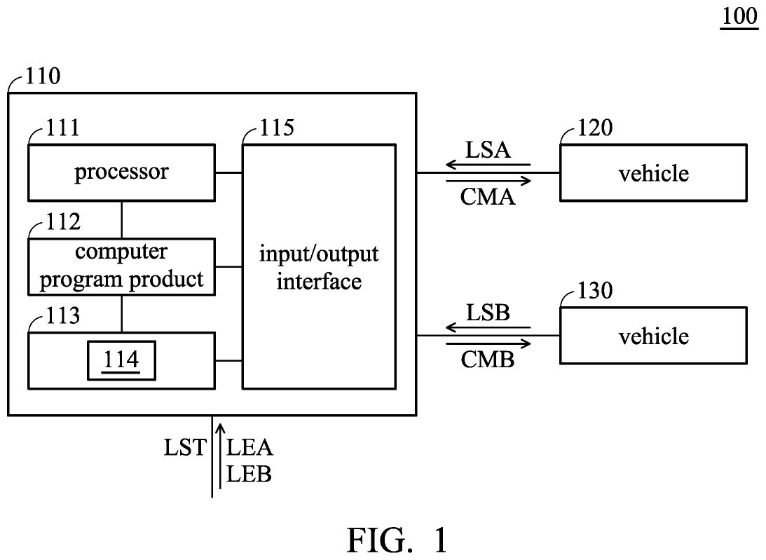

FIG. 1 is a schematic diagram showing a system for guiding vehicles according to an exemplary embodiment of the present invention. As shown in FIG. 1, the system for guiding vehicles 100 comprises a host terminal 110 and vehicles 120 and 130. The host terminal 110 comprises a processor 111 and a computer program product 112. When the processor 111 executes the computer program product 112, the host terminal 110 performs an interactive operation with at least one of the vehicles 120 and 130. The interactive operation refers to the communication between the host terminal 110 and the vehicles 120 and 130. In the embodiment, the vehicles 120 and 130 are unmanned vehicles, such as intelligent guided vehicles (IGV).

In the embodiment, when the processor 111 executes the computer program product 112, the host terminal 110 first simulates possible travelling paths of the vehicles 120 and 130 in a virtual field and then plans at least one optimal travelling path for the vehicles 120 and 130. Accordingly, the vehicles 120 and 130 can quickly reach their destinations. In addition, when the host terminal 110 is in the virtual field to simulate the travelling paths of the vehicles 120 and 130, the host terminal 110 can predict in advance that the vehicles 120 and 130 will collide in a specific region. In this case, the host terminal 110 may plan two non-overlapping paths for the vehicles 120 and 130 to avoid the collision therebetween or may establish travelling rules (going or stopping) to control the movement of the vehicles 120 and 130. For example, the host terminal 110 may require the vehicle 120 to stop when it moves to a stop point, and then continue to move after the vehicle 130 moves away from the stop point. The time when the vehicle 120 stops moving is also provided by the host terminal 110. In this example, when the host terminal 110 simulates the movement of the vehicles 120 and 130 in the virtual field, the host terminal 110 also determines how long the vehicle 120 needs to stay at the stop point in order to prevent the vehicles 120 and 130 from colliding with each other.

In the embodiment, the computer program product 112 of the host terminal 110 has an environment simulation program code, a traffic strategy management program code, and a task assignment program code. The environment simulation program code is used to simulate the actual environment characteristics of the actual field where the vehicles 120 and 130 are located and generate a virtual field. The traffic strategy management program code first simulates the movement of the vehicles 120 and 130 in the virtual field to predict possible problems (such as, the vehicles 120 and 130 colliding with each other or sticking in a narrow region) which are occurred when the vehicles 120 and 130 move, generates at least one optimal travelling path based on the prediction result, and defines travelling rules for the vehicles 120 and 130. The travelling rules indicate, for example, that the vehicles 120 and 130 cannot enter an excessively narrow region at the same time. The task assignment program code is used to assign tasks, a travelling rule, and an optimal travelling path to an appropriate vehicle to command the vehicle to move in the actual field.

In a possible embodiment, the environment simulation program code, the traffic strategy management program code, and the task assignment program code may be completed general programming languages (such as C, C++), hardware description languages (hardware description languages, HDL) (such as Verilog HDL (VHDL)), or other available programming languages. The invention does not intend to limit the type of the computer program product 112. In a possible embodiment, the computer program product 112 is a non-volatile memory, such as an erasable programmable read only memory (EPROM), and an electronically erasable programmable read only memory (EEPROM)), or a flash memory. In other embodiments, the computer program product 112 is a CD-ROM or a DVD-ROM.

First, the host terminal 110 needs to have a map. In a possible embodiment, the host terminal 110 has an input/output interface 115. In the example, the input/output interface 115 may receive a map 114 provided by the user and store the map 114 in a storage device 113. The invention does not intend to limit the type of the input/output interface 115. In a possible embodiment, the input/output interface 115 receives external information from the outside of the host terminal 110, such as a map 111, through a connection line. In another possible embodiment, the input/output interface 115 receives the map 114 in a wireless manner.

In other embodiments, the map 114 is generated by the host terminal 110 itself. In the example, the host terminal 110 has at least one wheel (not shown). When the wheel rotates, the host terminal 110 can move in a space. The host terminal 110 may use at least one laser sensor (not shown) to detect actual environmental characteristics of a field. In the example, the host terminal 110 generates the map 114 by combining the detection result of the laser sensor with a Simultaneous Localization and Mapping (SLAM) technology.

In other embodiments, the map 114 is generated by the vehicle 120 or 130. By taking the vehicle 120 as an example, the vehicle 120 moves in a space and uses at least one laser sensor to detect actual environmental characteristics of a field and generates the map 104 by combining the detection result with the SLAM technology. In a possible embodiment, the vehicle 120 may mark its position on the map 114 and then provide the map 114 to the input/output interface 115 in a wired or wireless manner. In the example, the input/output interface 115 stores the map 114 in the storage circuit 113. In some embodiments, the vehicle 120 may comprise a transmitter (not shown) which is used to provide the map 114 to the host terminal 110.

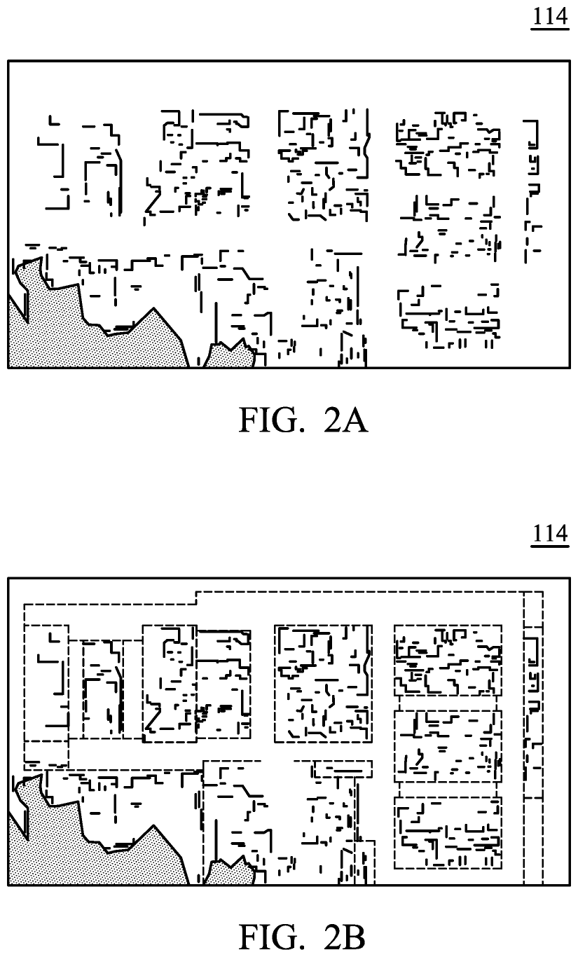

FIG. 2A is a possible schematic diagram of the map 114 according to one embodiment of the present invention. The environment simulation program code of the computer program product 112 obtains the actual boundaries (such as walls) of the field and the locations of the obstacles according to the map 114. In an embodiment, the map 114 shown in FIG. 2A is used as a virtual field. In the example, for finding the optimal travelling path, the host terminal 110 simulates the movement of the vehicles 120 and 130 by using the virtual field.

FIG. 2B is another possible schematic diagram of the map 114. In this embodiment, in order to prevent the vehicles 120 and 130 from entering too small regions, the user inputs blocking information LST through the input/output interface 115. The environmental simulation program code of the computer program product 112 of the host terminal 110 marks blocking marks (shown by the dotted lines) on the map 114 according to the blocking information LST. In the example, the region enclosed by the dotted lines is a region that the vehicles 120 and 130 cannot enter.

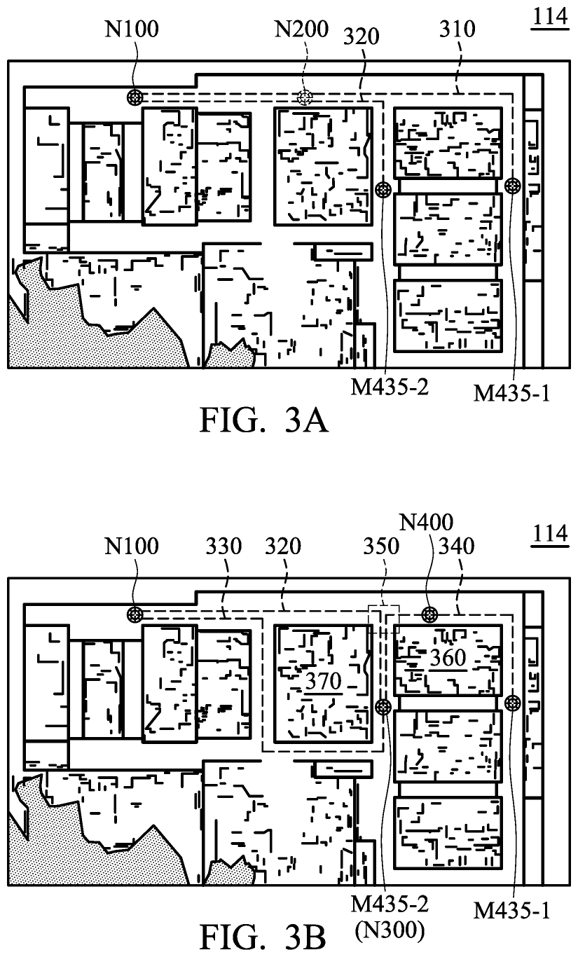

In the embodiment, the host terminal 110 receives the position information LSA and LSB reported by the vehicles 120 and 130 and marks the locations of the vehicles 120 and 130 on the map 114 according to the position information LSA and LSB. FIG. 3A is another schematic diagram of the map 114 of the present invention. The traffic strategy management program code of the computer program product 112 of the host terminal 110 marks the start position M435-1 of the vehicle 120 and the start position M435-2 of the vehicle 130 on the map 114 according to the position information LSA and LSB reported by the vehicles 120 and 130. In an embodiment, the host terminal 110 comprises at least one decoder which decodes the position information LSA and LSB reported by the vehicles 120 and 130. The host terminal 110 marks the start positions M435-1 and M435-2 on the map 114 according to the decoded result. In another embodiment, the host terminal 110 outputs the map 114 to the vehicles 120 and 130. By taking the vehicle 120 as an example, the vehicle 120 may detect the actual environment characteristics by using a laser sensor and compare the actual environmental characteristics with the environmental characteristics of the map 114 to learn about where the vehicle 120 is located on the map 114. In the example, the vehicle 120 marks its position on the map 114 and then sends the map 114 back to the host terminal 110.

In addition, the user may provide destination information LEA to the host terminal 110. In the example, the traffic strategy management program code of the computer program product 112 of the host terminal 110 obtains a destination location N100 according to the destination information LEA and marks the destination location N100 on the map 114. Then, the traffic strategy management program code simulates the possible travelling paths of the vehicles 120 and 130, as indicated by the symbols 310 and 320 (also referred to as “connection paths”) by using the start position M435-1 and M435-2 and the end position N100 in the map 114.

In a possible embodiment, since the connection path 320 is shorter than the connection path 310, the traffic strategy management program code regards the connection path 320 as an optimal path. In the example, since the connection path 320 is connected to the start position M435-2 of the vehicle 130, the task assignment program code of the computer program product 112 assigns a task to the vehicle 130.

The present invention does not intend to limit how the host terminal 110 controls the vehicles 120 and 130. For example, when the optimal travelling path planned by the traffic strategy management program code is related to the vehicle 120, the host terminal 110 generates a movement command CMA according to the optimal travelling path and the travelling rule planned by the traffic strategy management program code. In the example, the vehicle 120 moves and performs tasks according to the movement command CMA. When the optimal travelling path planned by the traffic strategy management program code is related to the vehicle 130, the host terminal 110 generates a movement command CMB according to the optimal travelling path and the travelling rule planned by the traffic strategy management program code. The vehicle 130 moves and performs tasks according to the movement command CMB.

In other embodiments, the user further provides midway-point information LEB. The traffic strategy management program code obtains a midway-point location N200 according to the midway-point information LEB and marks the midway-point location N200 on the map 114. Then, the traffic strategy management program code plans the connection paths 310 and 320 according to the start positions M435-1 and M435-2, the midway-point position N200, and the destination position N100. In the example, both of the connection paths 310 and 320 pass through the midway-point location N200.

The present invention does not intend to limit the data transmission method between the host terminal 110 and the vehicles 120 and 130. In an embodiment, the vehicles 120 and 130 upload the location information LSA and LSB to the cloud. In the example, the host terminal 110 retrieves the location information LSA and LSB from the cloud. In another embodiment, the vehicles 120 and 130 directly provide the location information LSA and LSB to the host terminal 110 by using a wireless method (such as Bluetooth). Similarly, the host 110 may upload the movement commands CMA and CMB to the cloud.

In other embodiments, when the host terminal 110 assigns tasks to the vehicles 120 and 130, it also informs the vehicles 120 and 230 of a location of a charging station. For example, when the remaining power of the vehicle 120 is too low, the vehicle 120 may first move toward a charging station for charging. After the remaining power of the vehicle 120 is sufficient, the vehicle 120 continues to perform the task. In an embodiment, there is a barcode pattern on the surface of the charging station for identification. When the host terminal 110 scans the surrounding environment, the host terminal 110 learns about the location of the charging station according to the barcode pattern of the charging station and marks the location of the charging station on the map 114.

FIG. 3B is another schematic diagram of the map 114 of the present invention. When the user inputs two records of destination information, the host terminal 110 generates destination locations N100 and N300 based on the two records of destination information and marks the destination locations N100 and N300 on the map 114 (referred to as “a virtual field”). As shown in FIG. 3B, the destination position N300 is the same as the start position M435-2 of the vehicle 130.

In an embodiment, the traffic strategy management program code plans the optimal travelling paths 320 and 340 according to the start positions M435-1 and M435-2, the destination positions N100 and N300, and the environmental characteristics of the map 114. The travelling path 320 is connected to the start position M435-2 and the destination position N100. The travelling path 340 is connected to the start position M435-1 and the destination position N300. In the example, when the vehicles 120 and 130 move to the region 350, a collision may occur. Therefore, the traffic strategy management program code sets a stop point N400 on the travelling path 340 and sets a travelling rule that indicates the vehicle 120 to move to the stop point N400, stop moving when it reaches the stop point N400, wait for a preset time (waiting for the vehicle 130 to pass the region 350), and then continue to move to the destination position N300 after the present time.

In another embodiment, if the distance between the regions 360 and 370 is wide enough to accommodate the vehicles 120 and 130 at the same time, the traffic strategy management program code does not set the stop point N400 on the travelling path 340. In the example, the traffic strategy management program code may define a new travelling rule in which the vehicle 120 is required to try to move on the boundary of the region when moving along the travelling path 340 and further define another new travelling rule in which the vehicle 130 is required to move on the boundary of the region 370 when moving along the travelling path 320.

In other embodiments, the traffic strategy management program code plans another travelling path 330. When the vehicles 120 and 130 move along the travelling paths 340 and 330 respectively, the vehicles 120 and 130 will not enter the region 350 at the same time. Therefore, the traffic strategy management program code does not need to additionally set the stop point N400 on the travelling path 340.

The traffic strategy management program code simulates the travelling paths of the vehicles 120 and 130 from the virtual field, which can avoid too many overlapping sections between the travelling paths and predict the problem in advance and then solve the problem (such as defining travelling rules or find new travelling paths). The traffic strategy management program code determines the most suitable travelling paths and travelling rules for vehicles 120 and 130. The task assignment program code then informs the corresponding vehicle (at least one of the vehicles 120 and 130) of the travelling path and the travelling rule determined by the traffic strategy management program code. Since the movement routes of the vehicles 120 and 130 have been properly planned, no problems will occur when they are moving.

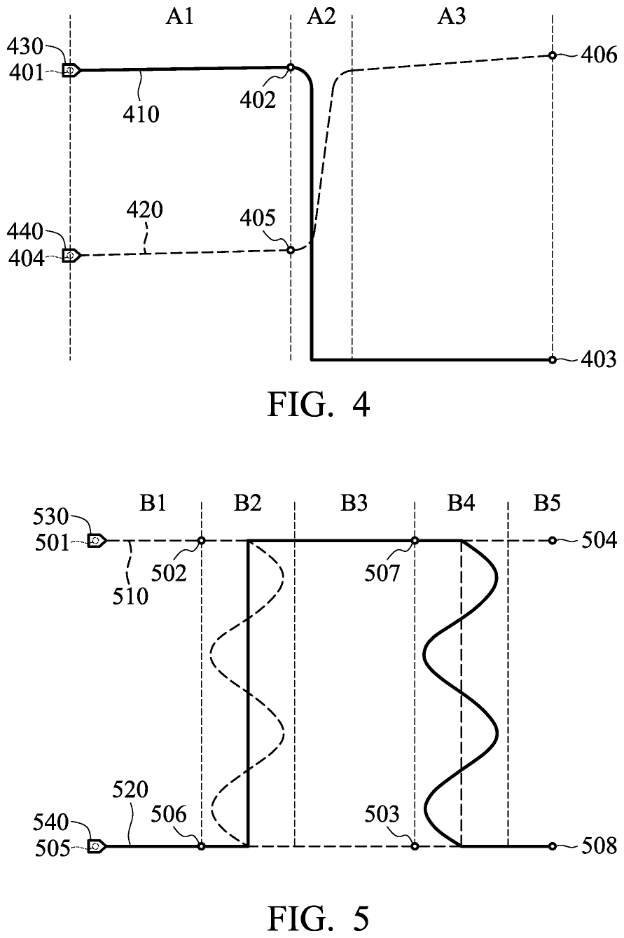

FIG. 4 is a schematic diagram showing the travelling paths of the present invention. For the convenience of description, FIG. 4 does not show the environmental characteristics of the virtual field. In the embodiment, the traffic strategy management program code plans optimal travelling paths 410 and 420 according to a start position 401 of a vehicle 430, a start position 404 of a vehicle 440, and destination positions 403 and 406. In the example, the vehicle 430 starts at the start position 401 and moves to the destination position 403 along the travelling path 410. In addition, the vehicle 440 moves from the start position 404 to the destination position 406 along the travelling path 420.

In the embodiment, although a section of the travelling path 410 overlaps the travelling path 420, because the travelling paths 410 and 420 are the optimal paths, the traffic strategy management program code defines the travelling rules for the vehicles 430 and 440, thereby avoiding collision between the vehicles 430 and 440. In an embodiment, the traffic strategy management program code firstly marks a stop point 402 on the travelling path 410 and further marks a stop point 405 on the travelling path 420. Then, the traffic strategy management program code estimates how long the vehicle 430 needs to wait for the vehicle 440 to pass the region A2 after the vehicle 430 reaches to the stop point 402 according to the movement speed of the vehicles 430 and 440. The traffic strategy management program code takes the time of the vehicle 430 waiting for at the stop point 402 as a first waiting time. In addition, the traffic strategy management program code also estimates how long the vehicle 440 needs to wait for the vehicle 430 to leave the region A2 after the vehicle 440 reaches to the stop point 405 and takes the time of the vehicle 440 waiting for at the stop point 405 as a second waiting time.

If the first waiting time is shorter than the second waiting time, the traffic strategy management program code keeps the stop point 402 on the travelling path 410 and deletes the stop point 405 on the travelling path 420. The task assignment program code of the host terminal provides the travelling path 410 with the stop point 402 to the vehicle 430 and provides the travelling path 420 without any stop point to the vehicle 440. The task assignment program code informs the vehicle 430 of the travelling rule and requires the vehicle 430 to stay at the stop point 402 for the first waiting time after it reaches the stop point 402 and then continue to move.

However, if the first waiting time is longer than the second waiting time, the traffic strategy management program code deletes the stop point 402 on the travelling path 410 and keeps the stop point 405 on the travelling path 420. The task assignment program code of the host terminal provides the travelling path 420 with the stop point 405 to the vehicle 440 and further provides the travelling path 410 without any stop point to the vehicle 430. The task assignment program code informs the travelling rule of the vehicle 440 and requires the vehicle 440 to stay at the stop point 405 for the second waiting time after it reaches the stop point 405 and then continue to move.

Since the traffic strategy management program code predicts that, according to the virtual field, a collision will occur when the vehicles 430 and 440 enter the region A2 at the same time, the traffic strategy management program code calculates the waiting time of each vehicle at the corresponding stop point, selects a shorter waiting time from multiple waiting times, and defines a travelling rule. Therefore, the time for each vehicle to reach the corresponding destination position will not increase significantly.

FIG. 5 is another schematic diagram showing travelling paths of vehicles of the present invention. The traffic strategy management program code plans the travelling paths 510 and 520 according to start position 501 of a vehicle 530, a start position 540 of a vehicle 540, and destination positions 504 and 508. As shown in FIG. 5, the vehicle 530 moves from the start position 501 to the destination position 504 along the travelling path 510. In addition, the vehicle 540 moves from the start position 505 to the destination position 508 along the travelling path 520.

As shown in FIG. 5, some sections of the travelling path 510 overlap the travelling path 520. Therefore, when the vehicles 530 and 540 enter one of the regions B2 and B4 at the same time, a collision between the vehicles 530 and 540 occurs. In the example, the traffic strategy management program code may first mark many stop points on the travelling paths 510 and 520. For example, since some sections of the travelling paths 510 and 520 overlap in the region B2, the traffic strategy management program sets stop points 502 and 506 in front of the region B2. In addition, the traffic strategy management program also sets stop points 503 and 507 in front of the region B4.

Next, the traffic strategy management program calculates how long the vehicle 530 needs to wait for the vehicle 540 to leave the region B2 after the vehicle 530 reaches the stop point 502. The time when the vehicle 530 stays at the stop point 502 is referred to as a first waiting time (for example, 16 seconds). After the vehicle 540 passes through the region B2, the vehicle 530 moves from the stop point 502 to the destination position 540 along the travelling path 510. When the vehicle 530 reaches the stop point 503, since the vehicle 540 may not have entered the region B4, the vehicle 530 does not need to stay at the stop point 503 and directly enters the region B4. The waiting time when the vehicle 530 stays at the stop point 503 is referred to as a second waiting time (for example, 0 seconds). When the vehicle 530 enters the region B4, if the vehicle 540 reaches the stop point 507, the vehicle 540 needs to stay at the stop point 507 and wait for the vehicle 530 to pass the region B4. At this time, the waiting time when the vehicle 540 stays at the stop point 507 is referred to as a third waiting time (for example, 23 seconds). After the vehicle 530 passes through the region B4, the vehicle 540 moves from the stop point 507 to the destination position 508 along the travelling path 520.

In addition, the traffic strategy management program code calculates a fourth waiting time (such as 23 seconds) when the vehicle 540 stays at the stop point 506 to wait for the vehicle 530 to pass through the region B2. After the vehicle 530 passes through the region B2, the vehicle 540 moves from the stop point 506 to the destination position 508 along the travelling path 520. When the vehicle 540 reaches the stop point 507, since the vehicle 530 may not have entered the region B4, the vehicle 540 does not need to stay at the stop point 507 and directly enters the region B4. However, when the vehicle 540 enters the region B4, if the vehicle 530 reaches the stop point 503, the vehicle 530 needs to stay at the stop point 503 and wait for the vehicle 540 to pass through the region B4. At this time, the waiting time when the vehicle 530 stays at the stop point 503 is referred to as a fifth waiting time (for example, 40 seconds). In this example, the waiting time (or referred to as a sixth waiting time) which the vehicle 540 stays at the stop point 507 is 0 seconds.

In an embodiment, the traffic strategy management program code defines travelling rules for the vehicles according to the first to sixth waiting time. For example, after the calculation by the traffic strategy management program code, the first waiting-time sum of the first waiting time (16 seconds) and the second waiting time (0 seconds) is 16 seconds, the second waiting-time sum of the first waiting time (16 seconds) and third waiting time (23 seconds) is 39 seconds, the third waiting-time sum of the fourth waiting time (23 seconds) and the fifth waiting time (40 seconds) is 63 seconds, and the fourth waiting-time sum of the fourth waiting time (23 seconds) and the sixth waiting time (0 seconds) is 23 seconds. Since the first waiting-time sum is the smallest, the traffic strategy management program code keeps the stop points 502 and 503 on the travelling path 510 and deletes the stop points 506 and 507. In addition, the traffic strategy management program code defines two travelling rules: one is to require the vehicle 530 to wait for the first waiting time at the stop point 502, and the other is to require the vehicle 530 to wait for the second waiting time at the stop point 503.

In the embodiment, the traffic strategy management program code calculates the waiting time of each vehicle at different stop points and defines a travelling rule according to the minimum waiting-time to avoid a collision between vehicles. Furthermore, since the traffic strategy management program code selects the most suitable vehicle to stop at a stop point, even if the vehicle stops a little while on the travelling path, it will not significantly delay the time at which the vehicle reaches the destination position.

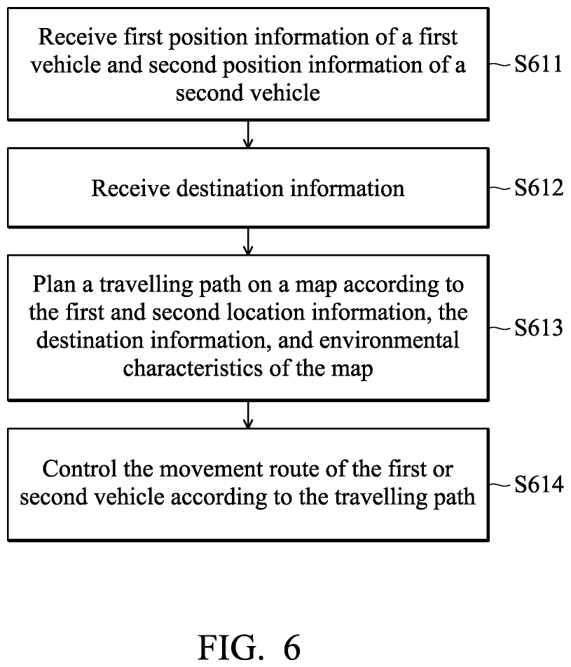

FIG. 6 is flow chart of a method for guiding vehicles according to the present invention. The method for guiding vehicles is applicable to a host terminal. The host terminal comprises a computer program product and a processor. When the processor executes the computer program product, the host terminal can communicate with a plurality of vehicles to control the behavior of the vehicles.

First, first position information of a first vehicle is received, and second position information of a second vehicle is also received (Step S611). In an embodiment, the host terminal may receive the first and second location information in a wired or wireless manner. In the example, the host terminal may receive the first and second location information through the Bluetooth communication protocol. In another embodiment, the host terminal downloads the first and second location information from the cloud. In the example, the first and second location information is uploaded to the cloud by the first and second vehicles upload.

Destination information is received (Step S612). In an embodiment, the host terminal may receive the destination information in a wired or wireless manner. Since the way the host terminal receives the destination information is similar to the way the host terminal receives the first location information, it will not be repeated. In other embodiments, the destination information is provided by the user.

A travelling path is planned on a map according to the first and second location information, the destination information, and environmental characteristics of the map (Step S613). In an embodiment, the host terminal decodes the first and second position information and the destination information to obtain start positions and destination positions of the first and second vehicles. In the example, the host terminal marks the start positions and the destination positions of the first and second vehicles on the map.

The present invention does not intend to limit the source of the map. In one embodiment, the map is provided by the user. In another embodiment, the map is generated by the host terminal. In the example, the computer program product of the host terminal has an environment simulation program code. When the processor executes the environment simulation program code, the host terminal may first move in a space to detect the characteristics of the surrounding environment and establish a map (or a virtual field) based on the detection result. In other embodiments, the map is generated by the first or second vehicle. By taking the first vehicle as an example, the vehicle moves in a space, detects actual environmental characteristics of a field by using at least one laser sensor, and generates a map by combining the detection result with the SLAM technology.

In an embodiment, the computer program product of the host terminal has a traffic strategy management program code to obtain a first connection path (such as the path 310 shown in FIG. 3) between the start position and the destination position of the first vehicle according to the environmental characteristics of the virtual field and further obtain a second connecting path (such as the path 320 shown in FIG. 3) between the start position and the destination position of the second vehicle. The traffic strategy management program code may calculate the length of the first and second connection paths and take the connection path with the shorter length as a travelling path.

According to the travelling path, the movement route of the first or second vehicle is controlled (step S614). In an embodiment, the computer program product of the host terminal has a task assignment program code. In the example, the task assignment program code provides a movement command to the first or second vehicle according to the travelling path selected by the traffic strategy management program code. For example, when the first connection path is taken as a travelling path, the task assignment program code assigns a task to the first vehicle. In the example, the task assignment program code provides a travelling path (possibly with a map) to the first vehicle to request the first vehicle to move along the travelling path. In another embodiment, when the second connection path is taken as a travelling path, the task assignment program code assigns task to the second vehicle. In the example, the task assignment program code provides a travelling path (possibly with a map) to the second vehicle to request the second vehicle to move along the travelling path.

In some embodiments, the maps received by the first and second vehicles include charging-station information. In the example, when the remaining power of the first or second vehicle is lower than a threshold value, the first or second vehicle moves toward the charging station according to the charging-station information included in the map. After the charging is completed, the first or second vehicle resumes performing the unfinished task.

The method for guiding vehicles of the present invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes processing circuits for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes processing circuits for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A system for guiding vehicles comprising:
a first vehicle configured to move in a first space;
a second vehicle configured to move in a second space; and
a host terminal comprising a computer program product and a processor,
wherein in response to the processor executing the computer program product, the host terminal performs an interactive operation with at least one of the first vehicle and the second vehicle, and
wherein the interactive operation comprises:
receiving first position information of the first vehicle;
receiving second position information of the second vehicle;
receiving destination information;
according to the first position information, the second position information, the destination information, and environmental characteristics of a map, planning a travelling path on the map; and
controlling a movement route of the first or second vehicle according to the travelling path.

2. The system for guiding vehicles as claimed in claim 1, wherein the interactive operation further comprises:
decoding the first position information to obtain a first start position of the first vehicle;
decoding the second position information to obtain a second start position of the second vehicle; and
decoding the destination information to obtain a destination position.

3. The system for guiding vehicles as claimed in claim 2, wherein the interactive operation further comprises:
obtaining a first connection path between the first start position and the destination position according to the environmental characteristics of the map;
obtaining a second connection path between the second start position and the destination position according to the environmental characteristics of the map; and
taking the first or second connection path as the travelling path.

4. The system for guiding vehicles as claimed in claim 3,
wherein in response to length of the first connection path being shorter than length of the second connection path, the first connection path is taken as the travelling path; and
wherein in response to the length of the second connection path being shorter than the length of the first connection path, the second connection path is taken as the travelling path.

5. The system for guiding vehicles as claimed in claim 1, wherein the interactive operation further comprises:
providing the map to the first vehicle, wherein the map comprises the travelling path.

6. The system for guiding vehicles as claimed in claim 5, wherein in response to remaining power of the first vehicle being lower than a threshold voltage, the first vehicle moves toward a charging station according to charging-station information included in the map.

7. The system for guiding vehicles as claimed in claim 2, wherein the host terminal further comprises:
at least one wheel; and
a laser sensor configured to detect actual environmental characteristics for generating the map.

8. The system for guiding vehicles as claimed in claim 7, wherein the host terminal provides the map to the first vehicle and the second vehicle, and the first vehicle marks a position of the first vehicle on the map, takes the map with the marked position as the first position information, and reports the first position information to the host terminal.

9. The system for guiding vehicles as claimed in claim 7, wherein the first vehicle comprises:
a laser sensor configured to detect environmental characteristics of the first space for generating the map provided to the host terminal.

10. The system for guiding vehicles as claimed in claim 1, wherein the first vehicle comprises:
a laser sensor configured to detect environmental characteristics of the first space for generating the map provided to the host terminal.

11. A method for guiding vehicles, applied to a host terminal, the host terminal comprising a computer program product and a processor and performing an interactive operation with a first vehicle or a second vehicle in response to the processor executing the computer program product, the method for guiding vehicles comprising:
receiving first position information of the first vehicle;
receiving second position information of the second vehicle;
receiving destination information;
according to the first position information, the second position information, the destination information, and a map, planning a travelling path on the map; and
controlling a movement route of the first or second vehicle according to the travelling path.

12. The method for guiding vehicles as claimed in claim 11, further comprising:
decoding the first position information to obtain a first start position of the first vehicle;
decoding the second position information to obtain a second start position of the second vehicle; and
decoding the destination information to obtain a destination position.

13. The method for guiding vehicles as claimed in claim 12, further comprising:
obtaining a first connection path between the first start position and the destination position;
obtaining a second connection path between the second start position and the destination position; and
taking the first or second connection path as the travelling path.

14. The method for guiding vehicles as claimed in claim 13,
wherein in response to length of the first connection path being shorter than length of the second connection path, the first connection path is taken as the travelling path; and
wherein in response to the length of the second connection path being shorter than the length of the first connection path, the second connection path is taken as the travelling path.

15. The method for guiding vehicles as claimed in claim 11, further comprising:
providing the map to the first vehicle, wherein the map comprises the travelling path.

16. The method for guiding vehicles as claimed in claim 15, wherein in response to remaining power of the first vehicle being lower than a threshold voltage, the first vehicle moves toward a charging station according to charging-station information included in the map.

17. The method for guiding vehicles as claimed in claim 11, further comprising:
providing the map to the first vehicle and the second vehicle,
wherein the first vehicle marks a position of the first vehicle on the map, takes the map with the marked position as the first position information, and reports the first position information to the host terminal.

18. A computer program product comprising a plurality of program codes, wherein in response to a computer loading the plurality of program codes, the method as claimed in claim 11 is completed.
